(19) United States
(12) Patent Application Publication
(10) Pub. No.: US 2021/0282420 A1
(43) Pub. Date: Sep. 16, 2021

(54) STRUCTURAL ARRANGEMENT FOR A THERMAL CHAMBER FOR MANUFACTURING HOME-MADE YOGURT

(71) Applicant: Gerhard Michel WOLF, São Paulo (BR)

(72) Inventor: Gerhard Michel WOLF, São Paulo (BR)

(21) Appl. No.: 16/609,530

(22) PCT Filed: Feb. 20, 2019
(86) PCT No.: PCT/BR2019/000005

§ 371 Date: Oct. 30, 2019

(30) Foreign Application Priority Data
Feb. 26, 2018 (BR) BR20 2018003675-6

(51) Int. Cl. A23C 9/123; A47J 41/00

(52) U.S. Cl. CPC A23C 9/123; A47J 41/00

(57) ABSTRACT

“CONSTRUCTIVE ARRANGEMENT IN A THERMAL CHAMBER FOR THE PRODUCTION OF HOME-MADE YOGHURT”, selectively chosen to be natural or greek, said thermal chamber being comprised of an outer container (casing) (1) provided with its respective lid (2); the said casing (1) embodied by an internal perimeter frame (3) next to its upper edge, which selectively accommodates and supports coaxially an inner container (4) and/or a filter container (6); wherein the inner container (4) has smaller dimensions than the casing (1), in a way that creates between the two structures a free perimeter space that works as an air chamber (5) which act as a thermal insulator to the thermal chamber (1, 2); being that the filter container (6), with slightly smaller dimensions when compared to the inner container (4), tightly fits in the inner container (4), but still with a depth not as profound as in the inner container (4), creating a collector interspace (7) between the bottom walls of both structures; the bottom wall of the filter container (6) is designed with a netting-like surface (6a), through which occurs the drainage of the liquid (serum) created during the processing of the milk volume kept in the thermal chamber, thus defined.

The present Utility Model describes a constructive arrangement in a thermal chamber for the production of home-made yoghurt and, more specifically, it details new aspects of a thermal segment for the production of home-made yoghurt in the options natural and/or greek, which the main diferenciative feature, when compared to the state of art existing yoghurt maker structures, consists in the use of a single container as the thermic insulating chamber that holds the necessary ingredients to produce home-made yoghurt selectively chosen to be natural or greek.

It is common knowledge that the production of home-made yoghurt is now a well spread practice, either due to the simplicity of obtaining the product (through milk fermentation) or to the extremely favorable cost-benefit rate of the home-made product, when compared to the industrialized yoghurts. The present state of the art contemplates several models of devices and/or equipments especially designed and built for the sole purpose of making it possible to produce home-made natural yoghurt. Although the state of art foresees a class of household appliances equipped with electric resistance and another class working with no power supply, this piece mentions only the second category because it is strictly related to the field of application of the current innovation now in request.

Among the appliances for production of home-made yoghurt that do not work on power supply there is the Utility Model Patent MU7402112-5, filled on Oct. 21, 1994, that proposes a “Kit for the production of yoghurt”, that has been developed by the present Applicant. The aforementioned kit foresees, briefly, a portable thermal chamber, a set of pots for housing the mixture to be fermented, a mixing spoon and a thermometer, wherein the thermal chamber itself is comprised of a polygon-shaped thermal cradle, defining a tightly closed vat that is closed by a thermal lid, being both the thermal chamber and its respective lid designed with double internal walls made of an isolating material that prevents the exchange of temperature between the mixture and the environment.

Still mentioning appliances for production of home-made yoghurt that do not work on power supply there is a more recent model directed on the Utility Model Patent MU8601016-6, filled on May 31, 2006, that proposes a “Constructive arrangement provided in a set for the production of home-made yoghurt”, also work of the present Applicant. This updated version compacts the appliance and all its pieces in a set comprised of a thermal chamber that is closed by a respective thermal lid, wherein both the chamber and its lid are provided with internal and external structures that define a hollow space that is filled with thermal insulating material. The thermal chamber has an essentially vertical and basically parallelepipedical configuration opening up internal space so it is possible to suitably arrange a number of items required for the practical production of home-made yoghurt; the set items being comprised of a doser milk jug and its respective lid, trays that are used as a support for the controlled positioning of individual pots, each one of which provided with its own lid; and a serum separating device.

The two aforementioned devices present their own designing particularities which allow their large scale production at a relatively low cost, when compared to the items pertaining to the class of state of the art household appliances.

Despite the high efficiency and reduced cost of manufacturing and commercialization, the products mentioned and object of patents MU7402112-5 and MU8601016-6 present aspects to be developed, either by its designing conception or its application. For this reason they were object of new studies and improvements, resulting in the constructive arrangement in a thermal chamber for the production of home-made yoghurt, here described, which had its development focused on design simplicity, on the reduction of items and also allowing a new option of home-made yoghurt to be produced.

This and other goals and advantages are achieved by a constructive arrangement in a thermal chamber for the production of home-made natural and greek yoghurt, selectively, wherein the thermal chamber comprises of an outer container (casing) provided with its respective lid; the casing embodied by an internal perimeter frame next to its upper edge, which accommodates and supports coaxially an inner container with upper edge that prolongs radially outwards with smaller dimensions than the casing, in a way that creates between the two structures a free perimeter space that works as an air chamber, said the cited casing is connected also coaxially to a filter container with upper edge that prolongs radially outwards with slightly smaller dimensions than the inner container, enabling a tight fit to the inner container, but still with a depth not as profound as in the inner container, creating a collector interspace between the bottom walls of both structures, said the bottom wall of the filter container is designed with a netting-like surface, through which occurs the drainage of the liquid (serum) created during the processing of the milk volume kept in the thermal chamber, thus defined.

The present innovation will be described in details with reference to the drawings shown below, wherein:

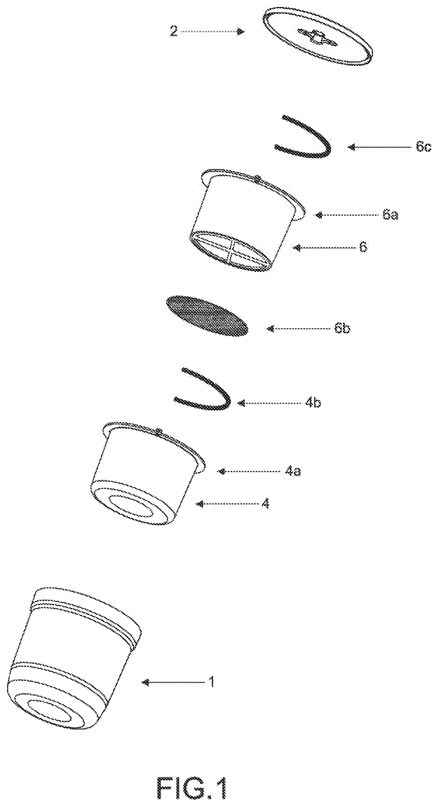

FIG. 1 illustrates a bottom level perspective exploded view of all items that make out the thermal chamber for producing home-made yoghurt;

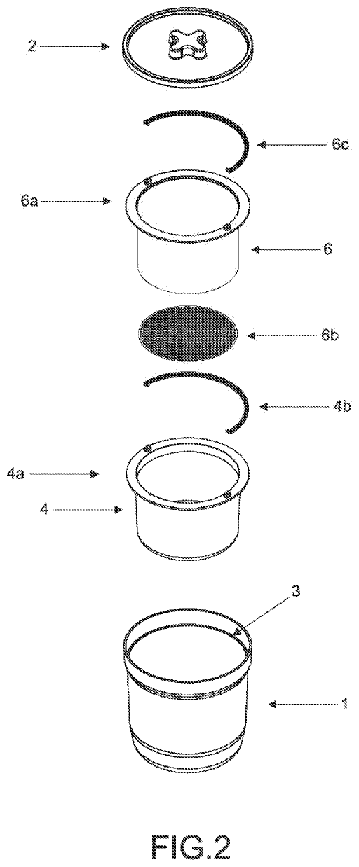

FIG. 2 illustrates a top level perspective exploded view of all items that make out the thermal chamber for producing home-made yoghurt;

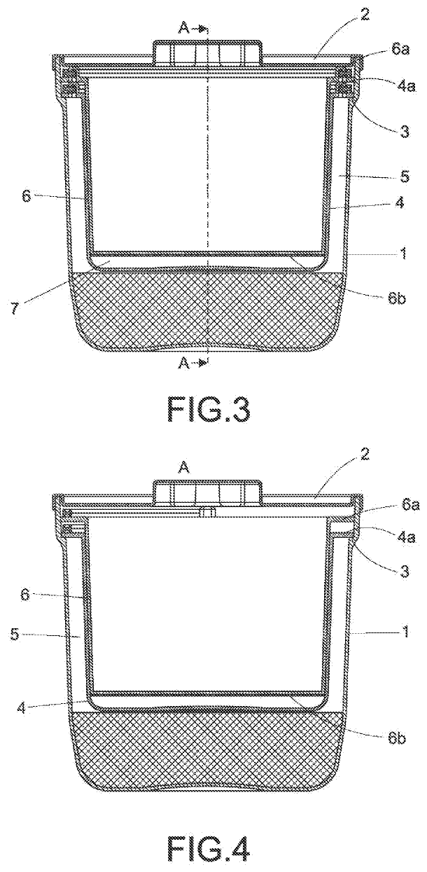

FIG. 3 illustrates a vertical diametric cut of the thermal chamber for producing home-made yoghurt in its assembled and closed condition;

FIG. 4 illustrates a vertical diametric cut from the perspective of Figure's 3 line “A-A” of the thermal chamber for producing home-made yoghurt in its assembled and closed condition;

FIG. 5 illustrates a vertical diametric cut of the thermal chamber for producing home-made yoghurt in the select assembled condition of a natural yoghurt; and

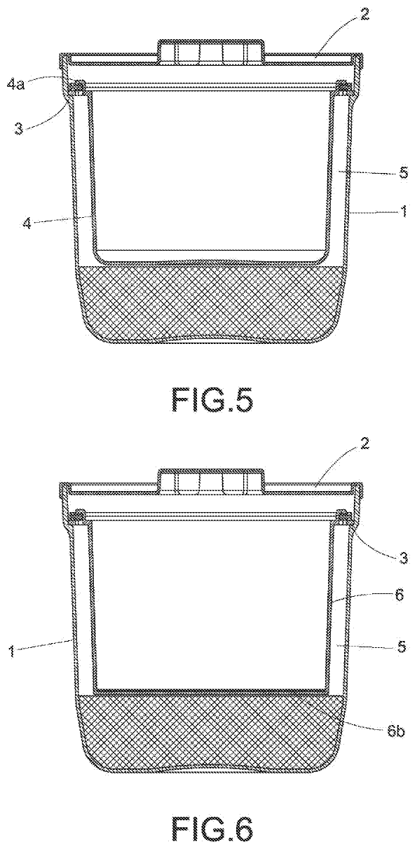

FIG. 6 illustrates a vertical diametric cut of the thermal chamber for producing home-made yoghurt in the select assembled condition of a greek yoghurt;

According to what is illustrated in the figures cited hereinabove, the constructive arrangement in a thermal chamber for the production of home-made yoghurt object of this innovation comprises of an outer container (casing) (1) with a preferably cylindrical shape and upper opening closed by its respective thermal lid (2), the said casing (1) embodied by an internal perimeter frame (3) next to its upper edge, which accommodates and supports the outward radial prolonged upper edge (4a) of an inner container (4) and/or the outward radial prolonged upper edge (6a) of a filter container (6).

The inner container (4) has smaller dimensions than the casing (1), in a way that creates between the two structures a free perimeter space that works as an air chamber (5) which act as a thermal insulator, as seen in the FIGS. 3, 4, 5 and 6.

With slightly smaller dimensions when compared to the inner container (4), the filter container (6) has a tight fit to this inner container (4), but still with a depth not as profound as in the inner container (4), creating a collector interspace (7) between the bottom walls of both structures, as seen in the FIGS. 3 and 4. The bottom wall of the filter container (6) is designed with a netting-like surface (6b), through which occurs the drainage of the liquid (serum) created during the processing of the milk volume kept in the thermal chamber, thus defined. On this design the serum created is naturally drained to the collector interspace (7) of the inner container (4).

As seen in the FIGS. 3, 4, 5 and 6 the inner container (4) and the filter container (6) can be set together or individually inside the outer container (1), being this configuration option the defining element of the yoghurt to be produced. With the filter component (6) on, it is produced greek yoghurt, because of the simultaneous fermentation and drainage of the milk mixture kept inside the casing (1) closed by its lid (2). Thus, it occurs the separation of the serum that is sent to the collector interspace (7) when applied the set in the FIG. 3, or it is sent to the bottom of the casing (1) when set as in the FIG. 6.

When the filter container (6) is not used, as seen in the FIG. 5, it is produced natural yoghurt, because the drainage of the serum occurs after the fermentation of the milk mixture kept inside the casing (1) closed by its lid (2), in other words, after its production, the yoghurt is removed from the thermal chamber and then it carries with the mechanical separation or the drainage of the serum created during the fermentation.

Every piece of the thermal chamber is preferably made of transparent plastic material, wherein the netting-like surface (6b) of the filter container (6) is composed by a removable stainless steel grid, easing its cleaning after every use. Along with the set goes a thermometer and a spoon, not represented, which act as monitoring and handling elements of the milk volume during the production of the yoghurt.

As illustrated in the FIGS. 1 and 2, handles for manual hold (4b and 6c) are foreseen to be pluggable to holes bored in the upper edges of the containers (4 and 6) to ease their insertion and detachment from the casing (1) when carried.

Another singularity of this constructive arrangement is in the fact that every piece (3, 4, 6, 6b) is designed to neatly fit inside the thermal chamber (1, 2), simplifying the availability of the set both when for sale and when idle and stored by the user at home.

As said before, the thermic insulating characteristic of this chamber (1, 2) occurs because of the free perimeter space (5) between the casing (1, 2) and the containers (4) and (6), wherein the air chamber created in this space act as a thermal insulator that during the process maintains the temperature of the milk mixture—previously heated between 37° C. (98.6° F.) and 45° C. (113° F.) before transferred to the outer container (1, 2)—allowing it to be fermented and thus producing natural or greek yoghurt.

1- “CONSTRUCTIVE ARRANGEMENT IN A THERMAL CHAMBER FOR THE PRODUCTION OF HOME-MADE YOGHURT”, selectively chosen to be natural or greek, is characterized by the fact that the thermal chamber comprises of an outer container (casing) (1) provided with its respective lid (2); the said casing (1) embodied by an internal perimeter frame (3) next to its upper edge, which selectively accommodates and supports coaxially an inner container (4) with radial upper edge (4a) and/or a filter container (6) with radial upper edge (6a); wherein the inner container (4) has smaller dimensions than the casing (1), in a way that creates between the two structures a free perimeter space that works as an air chamber (5) which act as a thermal insulator to the thermal chamber (1, 2); being that the filter container (6), with slightly smaller dimensions when compared to the inner container (4), tightly fits in the inner container (4), but still with a depth not as profound as in the inner container (4), creating a collector interspace (7) between the bottom walls of both structures; the bottom wall of the filter container (6) is designed with netting-like surface (6a), through which occurs the drainage of the liquid (serum) created during the processing of the milk volume kept in the thermal chamber, thus defined; being also foreseen at least one handle for manual hold (4b and 6c) to be pluggable to the containers (4 and 6) to their insertion and detachment from the casing (1).
